(19) United States
(12) Patent Application Publication
(10) Pub. No.: US 2026/0152178 A1
(43) Pub. Date: Jun. 4, 2026

(54) APPARATUS AND METHOD FOR CONTROLLING BLIND SPOT AVOIDANCE DRIVING AND VEHICLE SYSTEM INCLUDING THE SAME

(71) Applicants: Hyundai Motor Company, Seoul (KR); Kia Corporation, Seoul (KR)

(72) Inventors: Seung Hyeon Lee, Hwaseong-Si (KR); Sung Hyun JOE, Hwaseong-Si (KR); Ju Eun LEE, Hwaseong-Si (KR)

(21) Appl. No.: 19/270,964

(22) Filed: Jul. 16, 2025

(30) Foreign Application Priority Data
Dec. 3, 2024 (KR) 10-2024-0177777

(51) Int. Cl. B60W 30/14; B60W 30/09; B60W 30/095; B60W 30/16

(52) U.S. Cl. CPC B60W 30/143; B60W 30/09; B60W 30/0956; B60W 30/16; B60W 2520/105; B60W 2530/201; B60W 2552/53; B60W 2554/4041; B60W 2554/4042; B60W 2554/4048; B60W 2554/80

(57) ABSTRACT

An apparatus of a vehicle may comprise an input interface configured to receive driving information of at least one vehicle within a threshold distance from the vehicle, and a processor circuit configured to, based on the vehicle being positioned in a blind spot of the at least one vehicle, select, as objects of interest, the at least one vehicle, wherein the blind spot corresponds to a region that is not visible from a driver seat of the at least one vehicle, determine, based on a speed difference between the vehicle and each of the selected objects of interest, a risk area of interest, output a signal indicating an acceleration value and a deceleration value for escaping the blind spot, and control a driving speed of the vehicle.

### CROSS-REFERENCE TO RELATED APPLICATION

This application claims the benefit of priority to Korean Patent Application No. 10-2024-0177777, filed in the Korean Intellectual Property Office on Dec. 3, 2024, the entire contents of which are incorporated herein by reference.

### TECHNICAL FIELD

The present disclosure relates to a driving control apparatus and a driving control method for a vehicle, and more specifically, to a technique capable of controlling an autonomous vehicle to stably exit a blind spot of another vehicle in response to a case where the autonomous vehicle enters the blind spot.

### BACKGROUND

The matters described in this Background section are only for enhancement of understanding of the background of the disclosure, and should not be taken as acknowledgment that they correspond to prior art already known to those skilled in the art.

An autonomous vehicle may have a function to detect and process external information while driving, and may use this function to recognize surrounding environments, determine its own driving path, and drive independently using its own power.

The autonomous vehicle may manipulate a steering wheel, an accelerator pedal, and a brake pedal on its own, uses various sensors based on a precise map and a satellite navigation system (GPS) to understand its surroundings, and finds its way to its destination on its own.

For autonomous vehicles to become a reality, various automatic control technologies may be used, such as distance keeping, lane departure warning, lane keeping assist, rear/side warning, cruise control, and automatic emergency braking.

In a high-speed driving situation, such autonomous vehicles may enter a blind spot of another vehicle and cause a driver of another vehicle to not recognize the autonomous vehicle or to recognize it too late, which may lead to a dangerous situation.

Autonomous vehicles may not be equipped with a function to respond to a situation where they entered a blind spot of the other vehicle, making it impossible to prevent dangerous situations from occurring in advance.

Accordingly, there is a demand for development of a driving control apparatus that may prevent dangerous situations in advance by safely exiting the blind spot of the other vehicle in response to the case where the autonomous vehicle enters the blind spot.

### SUMMARY

An example of the present disclosure attempts to provide a driving control apparatus and a driving control method, and a vehicle system including the same, capable of safely escaping a blind spot of another vehicle and preventing a dangerous situation from occurring in advance by determining necessary acceleration and deceleration to escape the blind spot based on an avoidance priority of a risk area of interest in response to a case where a host vehicle is located in the blind spot of another vehicle.

The technical objects of the present disclosure are not limited to the objects mentioned above, and other technical objects not mentioned may be clearly understood by those skilled in the art from the description of the claims.

According to the present disclosure, an apparatus of a vehicle, the apparatus may comprise an input interface configured to receive driving information of at least one vehicle within a threshold distance from the vehicle, and a processor circuit configured to, based on the vehicle being positioned in a blind spot of the at least one vehicle, select, as objects of interest, the at least one vehicle, wherein the blind spot corresponds to a region that is not visible from a driver seat of the at least one vehicle, determine, based on a speed difference between the vehicle and each of the selected objects of interest, a risk area of interest for each of the selected objects of interest, output, based on the risk areas of interest, a signal indicating an acceleration value and a deceleration value for escaping the blind spot, and control, based on the signal, a driving speed of the vehicle.

The apparatus, wherein the processor circuit is configured to, obtain the driving information, filter, based on the driving information, the objects of interest, and search for a position of the blind spot of the at least one vehicle. The apparatus, wherein the processor circuit is configured to, determine, based on the driving information, a driving speed of the at least one vehicle, select, based on the driving speed of the at least one vehicle, a target vehicle, among the at least one vehicle, that is driving at a speed higher than a speed of the vehicle by at least a preset reference value, and exclude the selected target vehicle from being designated as an object of interest for filtering the objects of interest.

The apparatus, wherein the processor circuit is configured to, set a second point where a right lane boundary of a lane next to a current lane, in which the vehicle is located, meets a straight line drawn at a first angle from a first point at an upper left side of the vehicle, set a fourth point where the right lane boundary of the lane next to the current lane meets a straight line drawn at a second angle from a third point at a lower right side of the vehicle, and based on the vehicle being positioned within a region defined by the first, second, third, and fourth points, determine that the vehicle is positioned in the blind spot of the at least one vehicle.

The apparatus, wherein the processor circuit is configured to, set a fifth point where a left lane boundary of the current lane, in which the vehicle is located, meets a foot of a perpendicular drawn from the first point to the left lane boundary, set a sixth point where the right lane boundary of the lane next to the current lane meets a straight line drawn at a first angle from the fifth point, set a seventh point and an eighth point where the left lane boundary of the current lane, in which the vehicle is located, and the right lane boundary of the lane next to the current lane, respectively, meet a foot of a perpendicular drawn from the third point to the left lane boundary, and set a search range based on a position of the vehicle such that an area defined by the fifth, sixth, seventh, and eighth points may comprise the blind spot of the at least one vehicle.

The apparatus, wherein the processor circuit is configured to, set a sixth point where a left lane boundary of a lane next to a current lane, in which the vehicle is located, meets a straight line drawn at a first angle from a fifth point located at an upper right side of the vehicle, set an eighth point where the left lane boundary of the lane next to the current lane meets a straight line drawn at a second angle from a seventh point located at a lower left side of the vehicle, and based on the vehicle being positioned within a region defined by the fifth, sixth, seventh, and eighth points, determine that the vehicle is positioned in the blind spot of the at least one vehicle.

The apparatus, wherein the processor circuit is configured to, set a ninth point where a right lane boundary of the current lane, in which the vehicle is located, meets a foot of a perpendicular drawn from the fifth point to the right lane boundary, set a tenth point where the left lane boundary of the lane next to the current lane meets a straight line drawn at a first angle from the ninth point, set an eleventh point and a twelfth point where the right lane boundary of the current lane and the left lane boundary of the lane next to the current lane, respectively, meet a foot of a perpendicular drawn from the seventh point to the right lane boundary, and set a search range based on a position of the vehicle such that an area defined by the ninth, tenth, eleventh, and twelfth points may comprise the blind spot of the at least one vehicle.

The apparatus, wherein the processor circuit is configured to, set, based on a position of the vehicle, an area of interest in an area adjacent to the vehicle, and select, based on the at least one vehicle being positioned within the set area of interest, the objects of interest among the at least one vehicle.

The apparatus, wherein the processor circuit is configured to, based on a second vehicle traveling at a speed higher than a speed of the vehicle by at least a preset reference value, exclude the second vehicle positioned within the area of interest from the objects of interest, and select a third vehicle that is partially positioned within the area of interest as a candidate for one of the objects of interest.

The apparatus, wherein the processor circuit is configured to, based on a speed difference between the vehicle and each of the objects of interest, determine an expected position of each of the objects of interest after a predetermined time interval, determine, based on the expected position after the predetermined time interval, a blind spot for each of the objects of interest, and determine, among the determined blind spot for each of the objects of interest, a risk area of interest for each of the objects of interest.

The apparatus, wherein the processor circuit is configured to, identify, based on a position of the vehicle, intersections between a lane boundary of a current lane, in which the vehicle is driving, and a boundary of a blind spot of each of the objects of interest, determine, based on the identified intersections, an orthogonal point on the lane boundary of the current lane, and determine, based on the identified intersections and the determined orthogonal point, a risk area of interest for each of the objects of interest.

The apparatus, wherein the processor circuit is configured to, based on overlaps between the risk areas of interest for each of object of the selected objects of interest, divide the risk areas into non-overlapping risk areas of interest, and determine an avoidance priority for each of the non-overlapping risk areas of interest.

The apparatus, wherein the processor circuit is configured to, based on an overlapping area formed by overlaps between a plurality of risk areas of interest, determine whether a risk area of interest included in the overlapping area has a vertical width smaller than an overall length of the vehicle, and merge, based on the vertical width of the risk area of interest being smaller than the overall length of the vehicle, the overlapping area into an adjacent overlapping area. The apparatus, wherein the processor circuit is configured to determine the avoidance priority based on a distance from the vehicle and a number of the overlaps between the risk areas of interest.

The apparatus, wherein the processor circuit is configured to determine the avoidance priority based on, a first distance from a front bumper of the vehicle to an end point of a risk area of interest closest to a rear bumper of the vehicle, a second distance from the rear bumper of the vehicle to an end point of a risk area of interest closest to the front bumper of the vehicle, a median of the first distance and the second distance, a distance spanned by each of the risk areas of interest along a driving direction of the vehicle, a number of overlaps among the risk areas of interest, and a priority determination value determined based on the median, the distance, and the number of overlaps.

The apparatus, wherein the processor circuit is configured to, determine, based on a corresponding risk area of interest, a risk level of each of the objects of interest positioned in a lane adjacent to and in opposite direction from a current lane in which the vehicle is driving, select, based on the determined risk level of each of the objects of interest, an escape target position of the vehicle, and determine, based on a preset acceleration value, an acceleration value and a deceleration value for the vehicle to reach the escape target position.

The apparatus, wherein the processor circuit is configured to, determine that an object of interest is at a high risk based on, a minimum distance between a lane in a direction of the vehicle and the object of interest in a lane occupied by the object of interest being less than a first threshold, and a vertical distance between a center of the lane occupied by the object of interest and a center of the object of interest exceeding a second threshold.

The apparatus, wherein the processor circuit is configured to, based on absence of an object of interest having a risk level exceeding a threshold, select, as a point of the escape target position, a position where the vehicle exits the blind spot after a predetermined time period, and based on presence of an object of interest having a risk level exceeding the threshold, select, as a point of the escape target position, a position corresponding to a rear bumper of the object of interest having a risk level exceeding the threshold after the predetermined time period, to prevent the vehicle from passing adjacent to the object of interest having the risk level exceeding the threshold.

According to the present disclosure, an apparatus of a vehicle, the apparatus may comprise a processor, and a memory storing at least one instruction that, when executed by the processor communicating with the memory, is configured to cause the apparatus to, receive information related to positions and speeds of a plurality of vehicles within a threshold distance from the vehicle, determine whether the vehicle is located within a blind spot of at least one of the plurality of vehicles, wherein the blind spot corresponds to an area within a threshold range of angles extending rearward from a side mirror of the at least one of the plurality of vehicles, identify, based on a speed difference between the vehicle and each of the at least one of the plurality of vehicles, a risk area of interest for each of the at least one of the plurality of vehicles, output, based on the risk areas of interests, a signal indicating a target position for exiting the blind spot, and control, based on the signal, driving of the vehicle to move toward the target position.

According to the present disclosure, a method performed by an apparatus of a vehicle, the method may comprise receiving information related to positions and speeds of a plurality of vehicles within a threshold distance from the vehicle, determining whether the vehicle is located within a blind spot of at least one of the plurality of vehicles, wherein the blind spot corresponds to an area within a threshold range of angles extending rearward from a side mirror of the at least one of the plurality of vehicles, identifying, based on a speed difference between the vehicle and each of the at least one of the plurality of vehicles, a risk area of interest for each of the at least one of the plurality of vehicles, outputting, based on the risk areas of interests, a signal indicating a target position for exiting the blind spot, and controlling, based on the signal, driving of the vehicle to move toward the target position.

According to the present technique, it may be possible to prevent a dangerous situation that may arise in response to driving in a blind spot of another vehicle.

Furthermore, according to the present technique, it may be possible to enable safe driving without disrupting a highway traffic flow by accelerating and decelerating while considering an average speed of surrounding vehicles and a road speed limit.

Furthermore, various effects which may be directly or indirectly identified through the present specification may be provided.

### BRIEF DESCRIPTION OF THE DRAWINGS

FIG. 1 shows an example vehicle system including a driving control apparatus.

FIG. 2 shows an example blind spot avoidance driving of a vehicle.

FIG. 3 shows an example blind spot of a vehicle.

FIG. 4, FIG. 5, FIG. 6, FIG. 7, FIG. 8, FIG. 9, and FIG. 10, each shows a flowchart for describing an example blind spot avoidance driving control process of a driving control apparatus.

FIG. 11 and FIG. 12 show views for describing an example process of predicting blind spot entry of a driving control apparatus and selecting an escape target position.

FIG. 13 shows a flowchart for describing an example driving control method.

FIG. 14 shows an example computing system for a vehicle.

### DETAILED DESCRIPTION

Hereinafter, some examples of the present disclosure will be described in detail with reference to exemplary drawings. It should be noted that in adding reference numerals to constituent elements of each drawing, the same constituent elements include the same reference numerals as possible even though they are indicated on different drawings. In describing an example of the present disclosure, when it is determined that a detailed description of the well-known configuration or function associated with the example of the present disclosure may obscure the gist of the present disclosure, it will be omitted.

In describing constituent elements according to an example of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which an example of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of blind spot avoidance driving) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of blind spot avoidance driving) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of blind spot avoidance driving) described herein.

Minimum risk maneuver (MRM) operation(s) may also be controlled, for example, based on one or more features (e.g., features of blind spot avoidance driving) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of blind spot avoidance driving) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of blind spot avoidance driving) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., features of blind spot avoidance driving) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

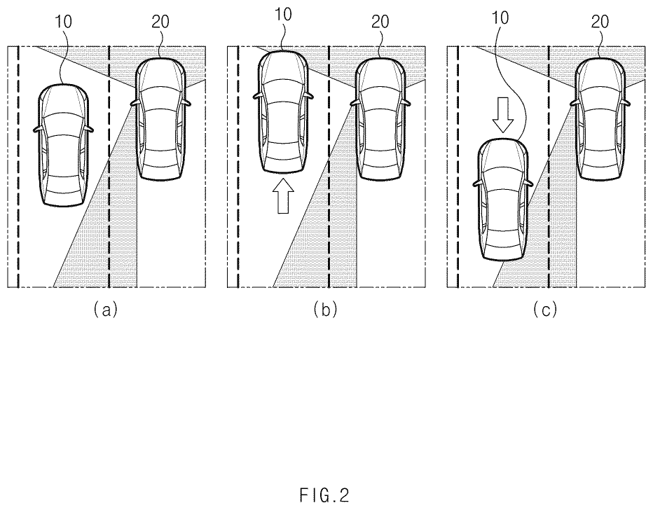

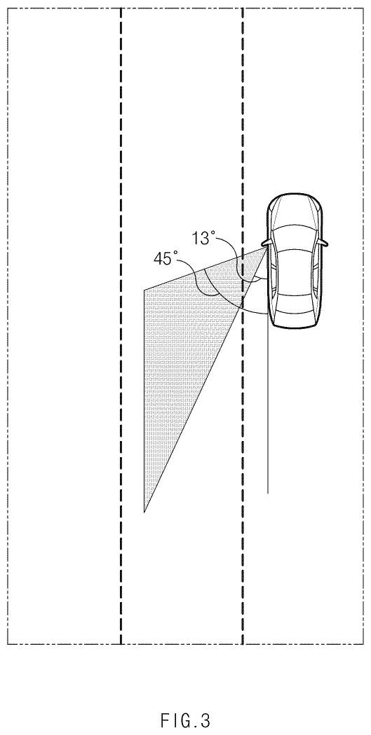

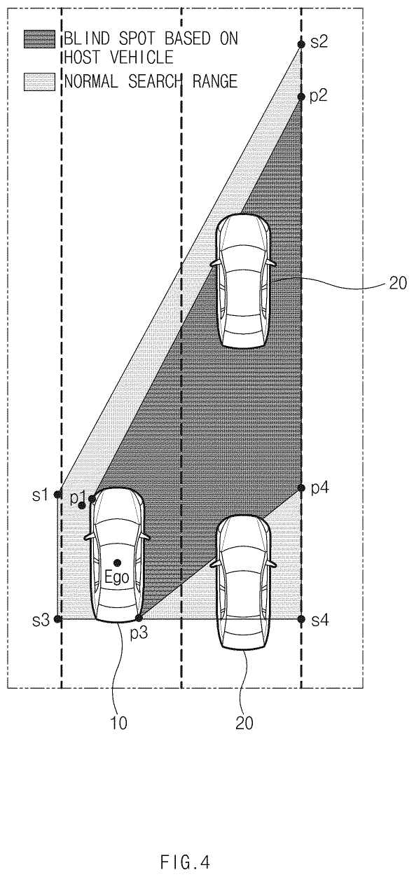

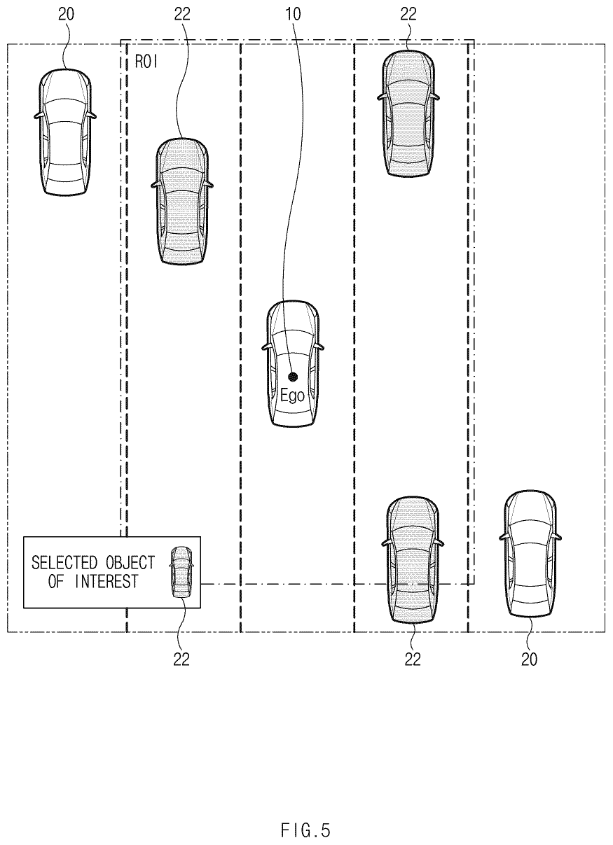

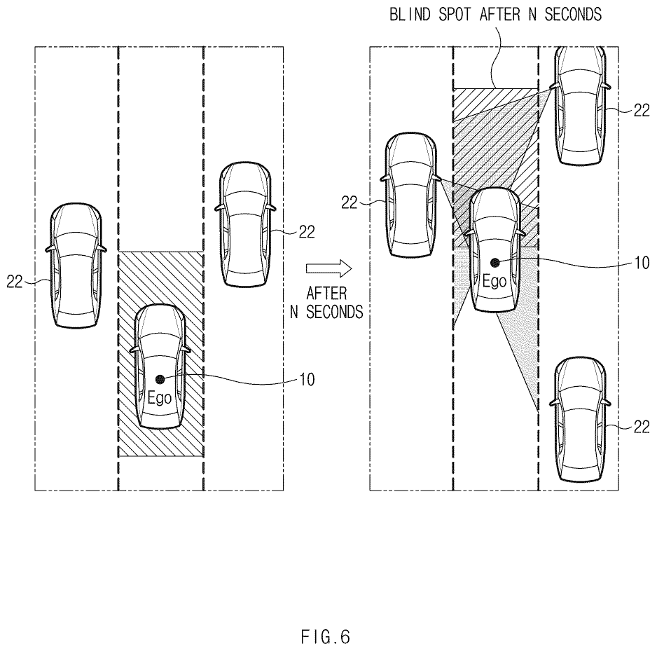

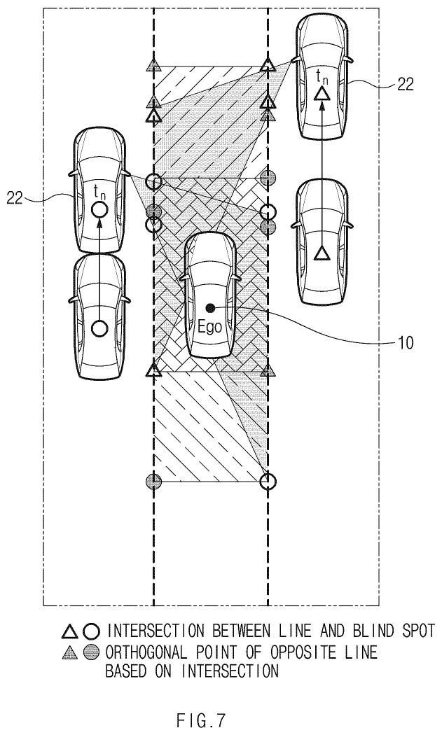

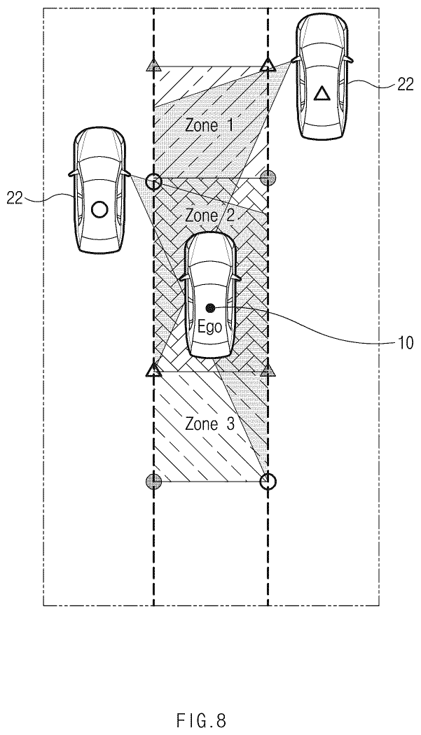

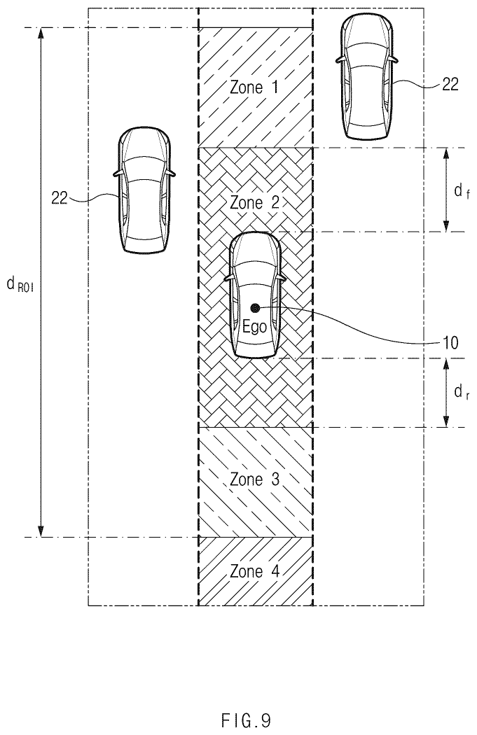

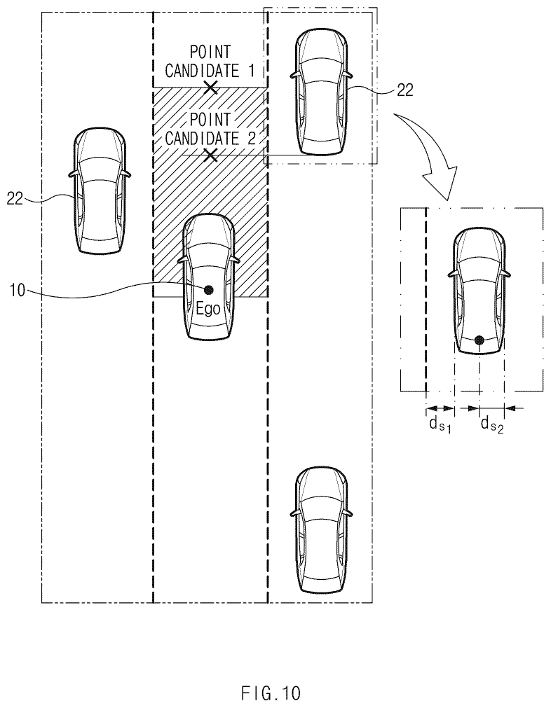

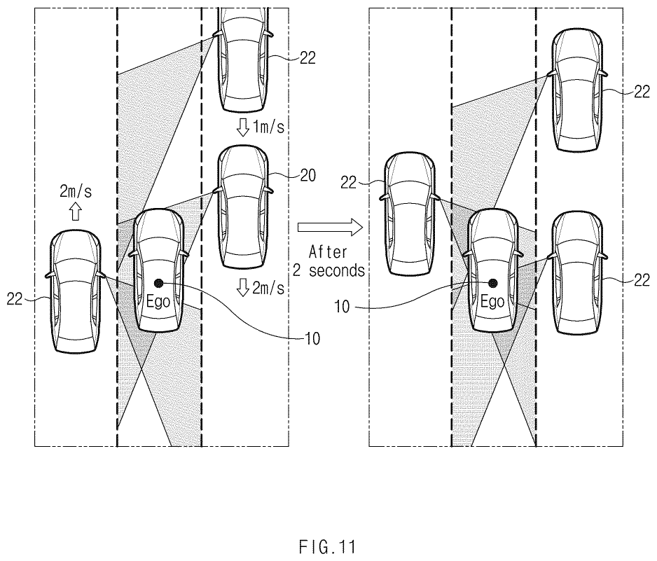

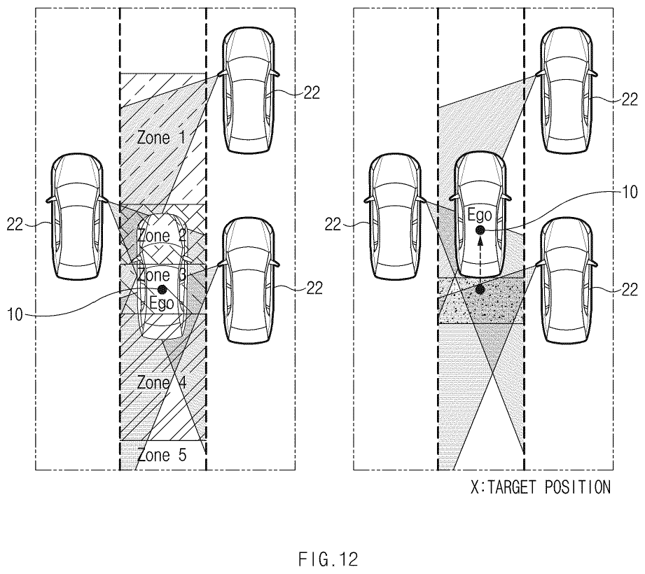

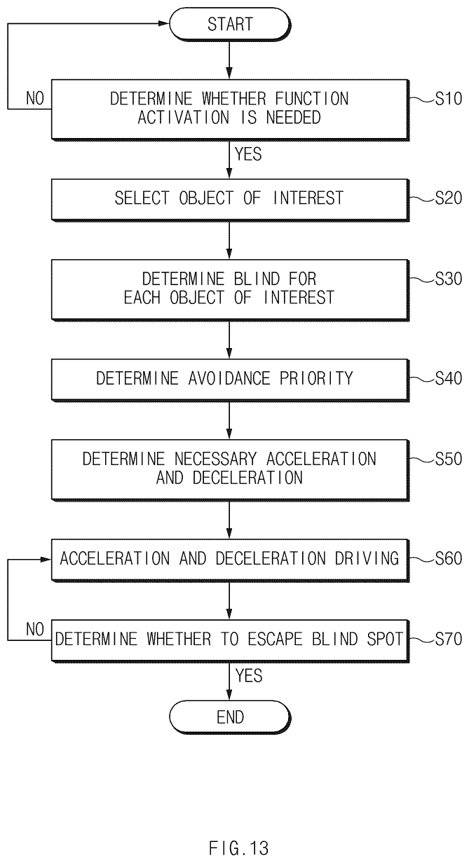

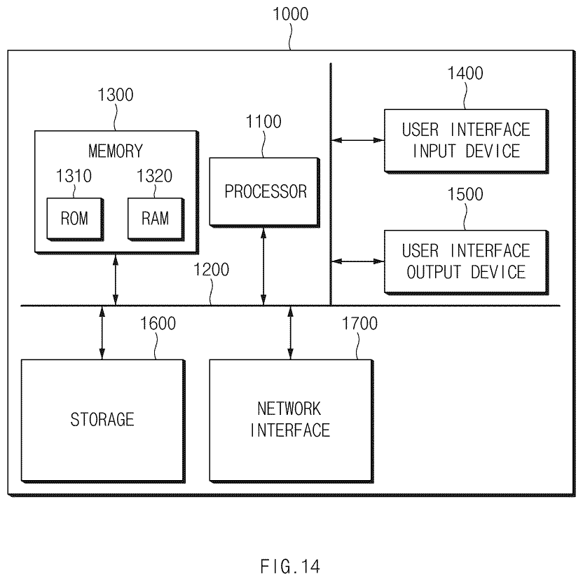

Hereinafter, various examples of the present disclosure will be described in detail with reference to IG. 1, FIG. 2, FIG. 3, FIG. 4, FIG. 5, FIG. 6, FIG. 7, FIG. 8, FIG. 9, FIG. 10, FIG. 11, FIG. 12, FIG. 13, and FIG. 14.

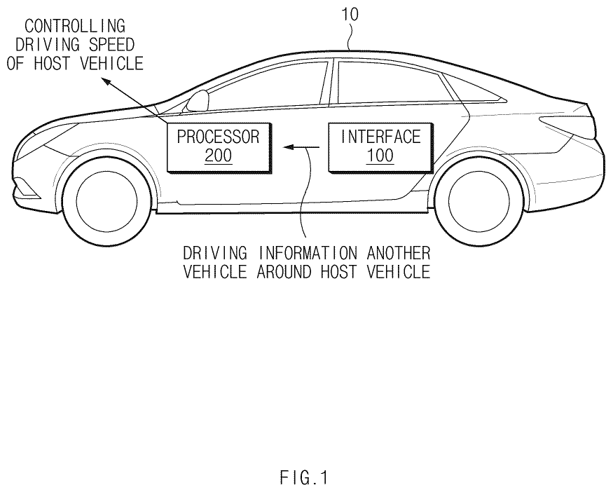

FIG. 1 shows an example vehicle system including a driving control apparatus.

As illustrated in FIG. 1, a vehicle 10 of the present disclosure may include a power control apparatus that controls a power of the host vehicle, and a driving control apparatus that controls the power control apparatus to accelerate or decelerate a driving speed of the vehicle in response to a case where the vehicle enters a blind spot of another vehicle around the vehicle, wherein the driving control apparatus may include modules such as adaptive cruise control systems, lane-keeping systems, or powertrain-integrated control units, etc.

Herein, the driving control apparatus may include an interface 100 into which driving information (e.g., GPS coordinates, speed, heading, or acceleration data, etc.) of surrounding vehicles is input, and a processor 200 configured to control a driving speed of the vehicle in response to entering the blind spot of the other vehicle (e.g., adaptive cruise control modules, lane-keeping systems, or powertrain-integrated control units, etc.).

The processor 200 may be configured to determine whether the host vehicle is positioned in the blind spot (e.g., between 13° and 45° rearward from a side mirror, depending on vehicle geometry and sensor field of view, etc.) of the other vehicle based on driving information (e.g., GPS coordinates, speed, heading, or acceleration data, etc.) of the other vehicle, select an object of interest from the other vehicle in response to a case where the host vehicle is positioned in the blind spot of the other vehicle, determine blind spots for each object of interest based on a relative speed of the selected object of interest, determine risk areas of interest for each object of interest from among the determined blind spots, determine an avoidance priority by dividing the risk areas of interest based on an overlap between the determined risk areas of interest, determine necessary acceleration and deceleration for escaping the blind spot (e.g., calculated to achieve lane departure within 2 seconds at a maximum acceleration of 2 m/s², etc.) corresponding to the avoidance priority, and control a driving speed of the host vehicle based on the necessary acceleration and deceleration.

Herein, the processor 200 may be configured to recognize an area positioned between about 13 degrees and about 45 degrees from a side mirror of another vehicle as a blind spot, but this is merely an example, and the present disclosure is not limited thereto.

Furthermore, to determine whether the host vehicle is positioned in the blind spot of the other vehicle, the processor 200 may be configured to obtain driving information (e.g., GPS coordinates, speed, heading, or acceleration data, etc.) of the other vehicle, filter objects of interest based on the driving information of the other vehicle, and search for a position of the blind spot of the other vehicle based on the host vehicle to determine whether the host vehicle is positioned in the blind spot of the other vehicle.

Herein, in response to filtering the objects of interest, the processor 200 may be configured to determine the driving speed of the other vehicle from the driving information of the other vehicle, select a vehicle that is driving at a preset reference speed (e.g., a system-defined threshold such as ±10 kph relative to host vehicle, etc.) or higher compared to a speed of the host vehicle based on the driving speed of the other vehicle, and filter the selected vehicle by not selecting it as an object of interest.

For example, the processor 200 may be configured to filter other vehicles traveling at a speed of about 10 kph or more compared to the host vehicle speed by not selecting it as the object of interest (e.g., vehicles rapidly overtaking in adjacent lanes, motorcycles weaving through traffic, or fast-moving trucks on highways, etc.), but this is merely an example, and the present disclosure is not limited thereto.

Then, in response to searching for a blind spot (e.g., between 13° and 45° rearward from a side mirror, depending on vehicle geometry and sensor field of view, etc.) position of the other vehicle based on the host vehicle, the processor 200 may be configured to set a point p2 where a right line of a next lane meets a straight line drawn at a 77 degree angle from an upper left point p1 of the host vehicle, set a point p4 where the right line of the next lane meets a straight line drawn at a 45 degree angle from a lower right point p3 of the host vehicle (e.g., forming the upper and lower bounds of a right-side blind spot detection region used for lane change safety evaluation, etc.), and determine that the host vehicle is positioned in the blind spot of the other vehicle in response to a case where the host vehicle is positioned within a range of p1, p2, p3, and p4.

Herein, the processor 200 may be configured to set a point where a left line of a host vehicle lane meets a foot of a perpendicular drawn from p1 thereto as s1, set a point where the right line of the next lane meets a straight line drawn at a 77 degree angle from s1 as s2, set points where the left line of the host vehicle lane and the right line of the next lane meet a foot of a perpendicular drawn from p3 to the left line, as s3 and s4, respectively (e.g., defining a bounded area to represent a forward right-side blind spot zone used for avoidance control logic, etc.), and set a normal search range such that an area surrounded by s1, s2, s3, and s4 includes the blind spot of the other vehicle based on the host vehicle.

For example, in response to setting the normal search range, the processor 200 may be configured to determine the normal search range based on a lane width, a size of the host vehicle, and a position of the host vehicle (e.g., vehicle offset within the lane, angle of approach, or sensor detection boundaries, etc.).

Then, in response to searching for the blind spot position of the other vehicle based on the host vehicle, the processor 200 may be configured to set a point p6 where a left line of the next lane meets a straight line drawn at a 77 degree angle from an upper right point p5 of the host vehicle, set a point p8 where the left line of the next lane meets a straight line drawn at a 45 degree angle from a lower left point p7 of the host vehicle (e.g., defining a triangular or trapezoidal region representing the left-side blind spot for dynamic risk assessment, etc.), and determine that the host vehicle is positioned in the blind spot of the other vehicle in response to a case where the host vehicle is positioned within a range of p5, p6, p7, and p8 (e.g., a quadrilateral zone behind the side mirror region used to geometrically define the blind spot boundary, etc.).

Herein, the processor 200 may be configured to set a point where a right line of the host vehicle lane meets a foot of a perpendicular drawn from p5 thereto as s5, set a point where the left line of the next lane meets a straight line drawn at a 77 degree angle from s5 as s6, set points where the right line of the host vehicle lane and the left line of the next lane meet a foot of a perpendicular drawn from p7 to the right line, as s7 and s8, respectively (e.g., forming a bounded region used to define the left-side blind spot zone for avoidance control logic, etc.), and set a normal search range such that an area surrounded by s5, s6, s7, and s8 includes the blind spot of the other vehicle based on the host vehicle (e.g., the region where visual obstruction and relative motion suggest elevated collision risk, etc.).

Furthermore, in response to selecting an object of interest, the processor 200 may be configured to set an area of interest in an adjacent area based on the host vehicle and select the object of interest from other vehicles positioned within the set area of interest (e.g., vehicles located in neighboring lanes within a 100-meter forward range and 50-meter rearward range of the host vehicle, etc.).

Herein, in response to setting the area of interest, the processor 200 may be configured to set a rectangular area including the left line and the right line as the area of interest based on 100 m in front and 50 m in the rear, which are half of a sensor confidence area of the host vehicle (e.g., the region covered by radar, lidar, or camera sensors for reliable object tracking, etc.).

Furthermore, in response to selecting an object of interest, the processor 200 may be configured to exclude another vehicle positioned within the area of interest from the object of interest in a case where the other vehicle is traveling at a higher preset reference speed compared to a speed of the host vehicle, and select a third vehicle that is partially positioned within the area of interest as a candidate for the object of interest (e.g., a slower-moving car merging into the lane, or a vehicle with variable speed but within lateral proximity, etc.).

Next, in response to determining the blind spot for each object of interest, the processor 200 may be configured to determine an expected position after n seconds based on a relative speed of the host vehicle and the object of interest, and determine the blind spot for each object of interest based on the expected position after n seconds (e.g., 2 seconds into the future assuming constant relative velocity, etc.).

For example, the processor 200 may be configured to set n seconds to 2 seconds to secure prediction reliability (e.g., to account for vehicle dynamics and sensor update intervals in short-term trajectory forecasting, etc.), but this is merely an example, and the present disclosure is not limited thereto.

For example, the processor 200 may be configured to determine the blind spot for each object of interest based on the expected position after n seconds in response to a case where the object of interest moves at a constant speed (e.g., vehicles traveling steadily on a highway or in light traffic, etc.).

Next, in response to determining a risk area of interest for each object of interest, the processor 200 may be configured to search for intersections of opposite lines of a driving lane and the blind spot of the object of interest based on the host vehicle, search for an orthogonal point of an opposite line thereto based on the intersections, and determine the risk area of interest for each object of interest based on the intersections and the orthogonal point (e.g., using geometric projections between lane boundaries and predicted blind spot zones, etc.).

Next, in response to dividing the risk area of interest, the processor 200 may be configured to divide the risk area of interest based on an overlap which occurs between risk areas of interest for each object of interest (e.g., overlapping projected paths from multiple adjacent vehicles, etc.).

Herein, the processor 200 may be configured to check whether there is a first overlapping area in which a vertical width of the risk area of interest is smaller than an overall length of the host vehicle in response to a case where the overlapping area includes a plurality of overlapping areas (e.g., narrow regions where multiple blind spots converge but are shorter than the host vehicle's length, such as during low-angle merges or lane splits, etc.), and merge the first overlapping area into an adjacent overlapping area in response to a case where there is the first overlapping area in which the vertical width of the risk area of interest is smaller than the overall length of the host vehicle (e.g., to simplify priority assessment and reduce unnecessary avoidance complexity, etc.).

Then, in response to determining the avoidance priority, the processor 200 may be configured to determine the avoidance priority for the divided risk areas of interest based on a distance from the host vehicle and a number of overlaps (e.g., giving higher priority to closer zones with frequent overlapping paths from multiple vehicles, etc.).

For example, the processor 200 may be configured to determine the avoidance priority for the divided risk areas of interest based on a formula W=(d_{ego}/d_{ROI})*N. (Herein, W indicates a priority determination value, d_{ego} indicates a median value of d_{f} and dᵣ, d_{ROI} indicates a total distance of the risk area of interest, N indicates the number of overlaps, d_{f} indicates a distance from a front bumper of the host vehicle to an end point of the risk area of interest closest to a rear bumper of the host vehicle, and dᵣ indicates a distance from the rear bumper of the host vehicle to the end point of the risk area of interest closest to the front bumper of the host vehicle (e.g., for use in calculating geometric balance between opposing ends of the risk zone, etc.).

Herein, the processor 200 may be configured to adjust the avoidance priority of the risk area of interest with a relatively large number of overlapping occurrences among the risk areas of interest to be increased (e.g., when multiple vehicles project risk zones onto a shared area, such as in dense urban traffic or multi-lane highway merging, etc.).

Furthermore, the processor 200 may be configured to adjust the avoidance priority of areas of interest that are relatively far from the host vehicle among the areas of interest to be increased (e.g., to provide earlier and smoother path planning for distant but growing risks, etc.).

Next, in response to determining the necessary acceleration and deceleration for escaping the blind spot, the processor 200 may be configured to check the risk of objects of interest positioned on opposite lines based on the risk area of interest, select an escape target position based on the risk of the object of interest, and determine the necessary acceleration and deceleration to the escape target position based on a preset acceleration (e.g., calculated within limits such as 2 m/s² to ensure stability and comfort, etc.).

Herein, in response to checking the risk of the object of interest, the processor 200 may be configured to determine the object of interest to be at a high risk in a case where a minimum distance dₛ₁ between a lane in a direction of the host vehicle and the object of interest in a lane occupied by the object of interest is less than a first distance, and a vertical distance dₛ₂ between a center of the lane occupied by the object of interest and a center of the object of interest exceeds a second distance (e.g., ds1<0.2 m and ds2>0.1 m may indicate lateral misalignment or unsafe drift, etc.).

For example, the first distance may be about 0.2 m and the second distance may be about 0.1 m (e.g., thresholds indicating potential side collision risk or lane intrusion, etc.), but this is merely an example, and the present disclosure is not limited thereto.

Then, in response to selecting the escape target position, the processor 200 may be configured to select a position where the host vehicle exits the blind spot after n seconds as a point of the escape target position in a case where there is no high-risk object of interest (e.g., selecting a forward lateral offset location in the adjacent lane to complete a safe merge, etc.), and select a position of the rear bumper of the object of interest after n seconds as a point of the escape target position so as not to pass next to a high-risk object of interest among the risk areas of interest in a case where there is a high-risk object of interest (e.g., to avoid lingering in proximity to erratic or misaligned vehicles, etc.).

Furthermore, in response to determining the required acceleration and deceleration, the processor 200 may be configured to determine an average speed of objects of interest within the area of interest and determine the required acceleration and deceleration based on the average speed of the objects of interest and the speed of the host vehicle (e.g., by averaging valid speed samples while excluding outliers exceeding a relative threshold, etc.).

For example, the preset acceleration may be less than about 2 m/s² (e.g., selected to balance response time with ride comfort and energy efficiency, etc.), but this is only an example, and the present disclosure is not limited thereto.

As such, according to the present disclosure, it may be possible to prevent a dangerous situation that may arise in response to driving in a blind spot of another vehicle (e.g., sudden lane changes or unnoticed merges, etc.).

Furthermore, according to the present disclosure, it may be possible to enable safe driving without disrupting a highway traffic flow by accelerating and decelerating while considering an average speed of surrounding vehicles and a road speed limit (e.g., adapting to typical speed patterns in high-occupancy lanes, merging zones, or construction corridors, etc.).

FIG. 2 shows an example blind spot avoidance driving of a vehicle.

As illustrated in FIG. 2A, the vehicle 10 of the present disclosure may obtain driving information such as a position and speed of another vehicle 20 (e.g., from onboard sensors such as radar, lidar, or V2V communication modules, etc.), and based on this, may determine whether the host vehicle 10 is positioned in a blind spot of the other vehicle 20, and select an object of interest from the other vehicle 20 in response to a case where the host vehicle 10 is positioned in the blind spot of the other vehicle 20.

Then, the vehicle 10 of the present disclosure may determine a blind spot for each object of interest based on a relative speed of the selected object of interest, determine risk areas of interest for each object of interest from the determined blind spots, determine an avoidance priority by dividing the risk areas of interest based on an overlap between the determined risk areas of interest, and determine necessary acceleration and deceleration for escaping the blind spot in accordance with the avoidance priority (e.g., by applying a weighted scoring system based on overlap density, proximity, and relative motion, etc.).

Next, as illustrated in FIG. 2B, the vehicle 10 of the present disclosure may escape the blind spot by controlling a driving speed of the vehicle 10 with the determined acceleration in response to a case where acceleration is required to escape the blind spot (e.g., when the adjacent lane is clear and the object of interest is approaching from the rear, etc.).

Next, as illustrated in FIG. 2C, the vehicle 10 of the present disclosure may control the driving speed of the vehicle 10 by determining the deceleration to escape the blind spot in response to a case where deceleration is necessary to escape the blind spot (e.g., when slowing down allows another vehicle to pass and clear the blind spot region, etc.).

FIG. 3 shows an example blind spot of a vehicle.

As illustrated in FIG. 3, the vehicle 10 of the present disclosure may recognize an area positioned between about 13 degrees and about 45 degrees from a side mirror of another vehicle as a blind spot (e.g., the region extending diagonally rearward that falls outside typical mirror coverage, etc.), but this is merely an example, and the present disclosure is not limited thereto.

Herein, the blind spot may indicate an area where a driver of another vehicle cannot see through a side mirror (e.g., due to mirror angle limitations or lack of wide-angle coverage, etc.).

FIG. 4, FIG. 5, FIG. 6, FIG. 7, FIG. 8, FIG. 9, and FIG. 10, each shows a flowchart for describing an example blind spot avoidance driving control process of a driving control apparatus.

FIG. 4 illustrates a view for describing a process of determining whether the host vehicle is positioned within a blind spot of another vehicle to determine whether function activation is needed by the driving control apparatus of the present disclosure.

As illustrated in FIG. 4, according to the present disclosure, it may be possible to determine whether the vehicle 10 is positioned in the blind spot of the other vehicle 20 based on the driving information (e.g., vehicle type, position, heading, and relative velocity, etc.) of the other vehicle 20.

Herein, according to the present disclosure, driving information of the other vehicle 20 may be obtained, an object of interest may be filtered based on the driving information of the other vehicle 20, and a blind spot position of the other vehicle 20 may be searched for based on the host vehicle 10 to determine whether the host vehicle 10 is positioned in the blind spot of the other vehicle 20 (e.g., by applying geometric calculations using lane boundaries and vehicle coordinates, etc.).

In the instant case, according to the present disclosure, the driving speed of the other vehicle 20 may be determined from the driving information of the other vehicle 20, the other vehicle 20 that is driving at a preset reference speed or higher compared to a host vehicle speed may be selected based on the driving speed of the other vehicle 20, and the selected vehicle 20 may be filtered by not selecting it as an object of interest (e.g., fast-moving vehicles expected to quickly exit the sensor range, etc.).

For example, according to the present disclosure, the other vehicle 20 traveling at a speed of about 10 kph or more compared to the host vehicle speed may be filtered by not selecting it as the object of interest (e.g., because such vehicles are likely to overtake and exit the detection region rapidly, etc.), but this is merely an example, and the present disclosure is not limited thereto.

The reason may be that, in a case of the other vehicle 20 traveling at a speed of about 10 kph or more compared to the host vehicle speed, it is determined that it will leave a sensor detection area of the host vehicle 10 within a few seconds (e.g., within 2 to 3 seconds depending on relative speed and sensor range, etc.).

Then, according to the present disclosure, in response to searching for a blind spot position of the other vehicle 20 based on the host vehicle 10, a point p2 where a right line of a next lane meets a straight line drawn at a 77 degree angle from an upper left point p1 of the host vehicle may be set, a point p4 where the right line of the next lane meets a straight line drawn at a 45 degree angle from a lower right point p3 of the host vehicle may be set (e.g., to define the upper and lower edges of a rear-side blind spot region used for detection and risk evaluation, etc.), and it may be determined that the host vehicle 10 is positioned in the blind spot of the other vehicle 20 in response to a case where the host vehicle is positioned within a range of p1, p2, p3, and p4 (e.g., forming a trapezoidal detection zone relative to the adjacent lane, etc.).

Herein, according to the present disclosure, a point where a left line of the host vehicle lane meets a foot of a perpendicular drawn from p1 thereto may be set as s1, a point where the right line of the next lane meets a straight line drawn at a 77 degree angle from s1 may be set as s2, points where the left line of the host vehicle lane and the right line of the next lane meet a foot of a perpendicular drawn from p3 to the left line, may be set as s3 and s4, respectively (e.g., outlining a geometric zone for blind spot estimation on the vehicle's right-hand side, etc.), and a normal search range may be set such that an area surrounded by s1, s2, s3, and s4 includes the blind spot of the other vehicle based on the host vehicle (e.g., forming a geometrically bounded region for spatial filtering, etc.).

For example, according to the present disclosure, in response to setting the normal search range, the normal search range may be determined based on a lane width, a size of the host vehicle, and a position of the host vehicle (e.g., center offset within lane, vehicle class dimensions, or GPS alignment error margins, etc.).

Furthermore, according to the present disclosure, in response to searching for a blind spot position of the other vehicle 20 based on the host vehicle 10, a point p6 where a left line of a next lane meets a straight line drawn at a 77 degree angle from an upper right point p5 of the host vehicle may be set, a point p8 where the left line of the next lane meets a straight line drawn at a 45 degree angle from a lower left point p7 of the host vehicle may be set (e.g., defining the upper and lower bounds of a left-side blind spot zone for angular field estimation, etc.), and it may be determined that the host vehicle 10 is positioned in the blind spot of the other vehicle 20 in response to a case where the host vehicle is positioned within a range of p5, p6, p7, and p8 (e.g., symmetric to the right-side configuration, covering blind spots on the driver's side, etc.).

Herein, according to the present disclosure, a point where a right line of the host vehicle lane meets a foot of a perpendicular drawn from p5 thereto may be set as s5, a point where the left line of the next lane meets a straight line drawn at a 77 degree angle from s5 may be set as s6, points where the right line of the host vehicle lane and the left line of the next lane meet a foot of a perpendicular drawn from p7 to the right line, may be set as s7 and s8, respectively (e.g., forming a quadrilateral zone for blind spot detection bounded by host and adjacent lane geometry, etc.), and a normal search range may be set such that an area surrounded by s5, s6, s7, and s8 includes the blind spot of the other vehicle based on the host vehicle e.g., forming a bounded polygonal zone used for lateral risk detection, etc.).

As such, according to the present disclosure, it may be possible to control blind spot avoidance driving such that the host vehicle 10 avoids blind spots in response to a case where the other vehicle 20 exists within the normal search range (e.g., during lane change maneuvers or traffic merging situations, etc.).

Herein, according to the present disclosure, it may be possible to control the blind spot avoidance driving such that the host vehicle 10 avoids blind spots even in a case where a portion of the other vehicle 20 is within the normal search range (e.g., vehicles partially entering the sensing region during a lateral drift or partial overtake, etc..

FIG. 5 illustrates a view for describing a process of selecting an object of interest by the driving control apparatus of the present disclosure.

As illustrated in FIG. 5, according to the present disclosure, it may be possible to select an object of interest 22 from the other vehicle 20 in response to a case where the host vehicle 10 is positioned in the blind spot of the other vehicle 20.

Herein, according to the present disclosure, an area of interest (restriction of interest (ROI)) may be set in an adjacent area based on the host vehicle, and the object of interest 22 may be from other vehicles positioned within the set area of interest (e.g., vehicles in neighboring lanes within a 150-meter span around the host vehicle, etc.).

For example, according to the present disclosure, in response to setting an area of interest (ROI), a rectangular area including the left line and the right line may be set as the area of interest (ROI) based on 100 m in front and 50 m in the rear, which is half of the sensor reliability area of the host vehicle 10 (e.g., derived from sensor accuracy models and confidence zones for vision and radar systems, etc.).

Furthermore, in response to selecting the object of interest 22, another vehicle positioned within the area of interest (ROI) may be excluded from the object of interest in a case where the other vehicle is traveling at a higher preset reference speed compared to a speed of the host vehicle, and a third vehicle that is partially positioned within the area of interest may be selected as a candidate for the object of interest 22 (e.g., slower-moving vehicles that pose potential collision risks during blind spot exit, etc.).

FIG. 6 illustrates a view for describing a process of determining a blind spot for each object of interest by the driving control apparatus of the present disclosure.

As illustrated in FIG. 6, according to the present disclosure, it may be possible to determine the blind spot for each object of interest based on a relative speed of the selected object of interest 22 (e.g., whether the object of interest is closing in or pulling away from the host vehicle, etc.).

Next, according to the present disclosure, in response to determining the blind spot for each object of interest, it may be possible to determine an expected position after n seconds based on a relative speed of the host vehicle 10 and the object of interest 22, and determine the blind spot for each object of interest based on the expected position after n seconds (e.g., using predictive modeling to extend the blind spot boundary based on anticipated positions, etc.).

For example, according to the present disclosure, it may be possible to set n seconds to 2 seconds to secure prediction reliability (e.g., accounting for typical sensor update rates and safe lane change response times, etc.), but this is merely an example, and the present disclosure is not limited thereto.

As another example, according to the present disclosure, it may be possible to determine the blind spot for each object of interest 22 based on the expected position after n seconds in response to a case where the object of interest moves at a constant speed (e.g., during steady-state highway driving or platooning scenarios, etc.).

FIG. 7 illustrates a view for describing a process of determining a risk area of interest for each object of interest by the driving control apparatus of the present disclosure.

As illustrated in FIG. 7, according to the present disclosure, it may be possible to determine the risk area of interest for each object of interest from among the generated blind spots (e.g., by identifying zones most likely to pose safety threats during lane changes or merging, etc.).

Next, according to the present disclosure, in response to determining a risk area of interest for each object of interest, it may be possible to search for intersections of opposite lines of a driving lane and the blind spot of the object of interest 22 based on the host vehicle 10, search for an orthogonal point of an opposite line thereto based on the intersections, and determine the risk area of interest for each object of interest based on the intersections and the orthogonal point (e.g., forming a polygonal danger zone to facilitate avoidance path planning, etc.).

FIG. 8 and FIG. 9 illustrate a view for describing a process of dividing a risk area of interest to determine an avoidance priority by the driving control apparatus of the present disclosure.

As illustrated in FIGS. 8 and 9, according to the present disclosure, it may be possible to determine the avoidance priority by dividing the area of interest based on an overlap between determined areas of interest (e.g., prioritizing regions shared by multiple blind spots or those closest to vehicle path projections, etc.).

As in FIG. 8, according to the present disclosure, in response to dividing the risk area of interest, it may be possible to divide the risk area of interest based on an overlap which occurs between risk areas of interest for each object of interest (e.g., overlapping projected zones from multiple adjacent vehicles that may indicate compounded collision risks, etc.).

Herein, according to the present disclosure, it may be possible to determine whether there is an overlapping area in which a vertical width of the risk area of interest is smaller than an overall length of the host vehicle 10 in response to a case where the overlapping area has multiple overlapping areas (e.g., when two or more blind spots intersect narrowly across adjacent lanes, etc.), and merge a corresponding overlapping area into an adjacent overlapping area in response to a case where there is an overlapping area in which the vertical width of the risk area of interest is smaller than the overall length of the host vehicle 10 (e.g., to consolidate narrow low-priority regions with larger adjacent zones for more effective avoidance decisions, etc.).

Then, as in FIG. 9, in response to determining the avoidance priority, it may be possible to determine the avoidance priority for the divided risk areas of interest based on a distance from the host vehicle 10 and a number of overlaps (e.g., assigning higher urgency to closer regions with more overlapping threat vectors, etc.).

For example, according to the present disclosure, it may be possible to determine the avoidance priority for the divided risk areas of interest based on a formula W=(d_{ego}/d_{ROI})*N. (Herein, W indicates a priority determination value, d_{ego} indicates a median value of d_{f} and dᵣ, d_{ROI} indicates a total distance of the risk area of interest, N indicates the number of overlaps, d_{f} indicates a distance from a front bumper of the host vehicle to an end point of the risk area of interest closest to a rear bumper of the host vehicle, and dᵣ indicates a distance from the rear bumper of the host vehicle to the end point of the risk area of interest closest to the front bumper of the host vehicle (e.g., geometric symmetry between threat boundaries along the host vehicle's longitudinal axis, etc.).

Herein, according to the present disclosure, it may be possible to adjust the avoidance priority of the risk area of interest with a relatively large number of overlapping occurrences among the risk areas of interest to increase the priority level (e.g., prioritizing zones influenced by more than two overlapping blind spots, etc.).

Furthermore, according to the present disclosure, it may be possible to adjust the avoidance priority of areas of interest that are relatively far from the host vehicle 10 among the areas of interest to increase the priority level (e.g., to initiate early avoidance maneuvers and improve transition smoothness in advance of actual risk onset, etc.).

FIG. 10 illustrates a view for describing a process of determining necessary acceleration and deceleration for escaping from a blind spot by the driving control apparatus of the present disclosure.

As illustrated in FIG. 10, according to the present disclosure, it may be possible to determine the necessary acceleration and deceleration for escaping from the blind spot in accordance with the avoidance priority and control a driving speed of the host vehicle 10 based on the necessary acceleration and deceleration (e.g., by applying a smooth speed adjustment curve based on urgency levels, etc.).

Next, according to the present disclosure, in response to determining the necessary acceleration and deceleration for escaping the blind spot, it may be possible to check the risk of objects of interest 22 positioned on opposite lines based on the risk area of interest, select an escape target position based on the risk of the object of interest 22, and determine the necessary acceleration and deceleration to the escape target position based on a preset acceleration (e.g., maintaining values within system-defined comfort and safety thresholds such as ±2 m/s², etc.).

Herein, according to the present disclosure, in response to checking the risk of the object of interest 22, it may be possible to determine that the object of interest 22 is at a high risk in a case where a minimum distance dₛ₁ between a lane in a direction of the host vehicle and the object of interest 22 in a lane occupied by the object of interest 22 is less than a first distance, and a vertical distance dₛ₂ between a center of the lane occupied by the object of interest 22 and a center of the object of interest 22 exceeds the second distance (e.g., indicating lateral drift or lane deviation, etc.).

For example, the first distance may be about 0.2 m and the second distance may be about 0.1 m (e.g., thresholds derived from safety margin studies for adjacent lane tracking, etc.), but this is merely an example, and the present disclosure is not limited thereto.

Then, according to the present disclosure, in response to selecting the escape target position, it may be possible to select a position where the host vehicle 10 exits the blind spot after n seconds as a point (Point candidate 1) of the escape target position in a case where there is no high-risk object of interest 22, and select a position of the rear bumper of the object of interest after n seconds as a point (Point candidate 2) of the escape target position so as not to pass next to a high-risk object of interest among the risk areas of interest in a case where there is a high-risk object of interest 22 (e.g., to avoid adjacent lane conflict with erratic vehicles, etc.).

Furthermore, according to the present disclosure, in response to determining the required acceleration and deceleration, it may be possible to determine an average speed of objects of interest 22 within the area of interest and determine the required acceleration and deceleration based on the average speed of the objects of interest 22 and the speed of the host vehicle 10 (e.g., using a dynamic reference model to minimize abrupt changes in velocity, etc.).

For example, the preset acceleration may be less than about 2 m/s² (e.g., to maintain passenger comfort and comply with regulatory acceleration limits, etc.), but this is only an example, and the present disclosure is not limited thereto.

FIG. 11 and FIG. 12 show views for describing an example process of predicting blind spot entry of a driving control apparatus and selecting an escape target position.

As illustrated in FIG. 11, according to the present disclosure, in a situation where there are three or more objects of interest 22 of other vehicles 20 around the host vehicle 10, and there are objects of interest 22 accelerating at about 2 m/s relative to a speed of the host vehicle 10, objects of interest 22 decelerating at about 1 m/s, and objects of interest 22 decelerating at about 2 m/s, it may be possible to attempt evasive driving because the host vehicle 10 is positioned in the blind spot of the objects of interest 22 of the surrounding vehicles (e.g., multi-vehicle convergence during lane changes or merging on a congested highway, etc.).

Herein, according to the present disclosure, the objects of interest 22 of the surrounding vehicles may have a difference in relative speed from the host vehicle 10, as shown in FIG. 11, so a state about 2 seconds later may be predicted based on the relative speed of the objects of interest 22, and avoidance driving may be attempted in response to a case where the host vehicle 10 is positioned in the blind spots of the objects of interest 22 (e.g., predicting future spatial overlaps using uniform motion assumption, etc.).

Then, as illustrated in FIG. 12, in response to a case where there are three or more objects of interest 22 of other vehicles around the host vehicle 10, it may be possible to select a candidate group of risk areas of interest, e.g., a first zone (Zone 1), a second zone (Zone 2), a third zone (Zone 3), a fourth zone (Zone 4), and a fifth zone (Zone 5), by using the blind spots of the objects of interest 22 (e.g., geometric overlays derived from each object's rearward angular projection, etc.).

Herein, according to the present disclosure, it may be possible to select the third zone (Zone 3) as a zone with a highest avoidance priority, select an escape target position in the third zone (Zone 3), and determine the acceleration and deceleration required to reach the escape target position based on a preset acceleration (e.g., such as ≤2 m/s², depending on traffic smoothness requirements and safety limits, etc.).

FIG. 13 shows a flowchart for describing an example driving control method.

As illustrated in FIG. 13, according to the present disclosure, it may be determined whether a function needs to be activated by determining whether a host vehicle is positioned in a blind spot of another vehicle based on driving information of the other vehicle (S10) (e.g., derived from V2V messaging, sensor fusion, or historical movement patterns, etc.).

Herein, according to the present disclosure, it may be possible to obtain driving information of the other vehicle, filter objects of interest based on the driving information of the other vehicle, and search for a position of a blind spot of the other vehicle based on the host vehicle to determine whether the host vehicle is positioned in the blind spot of the other vehicle (e.g., using GPS coordinates, relative heading, and vehicle geometry data, etc.).

Furthermore, according to the present disclosure, it may be possible to select an object of interest from the other vehicle in response to a case where the host vehicle is positioned in the blind spot of the other vehicle (S20).

Herein, according to the present disclosure, in response to selecting the object of interest, it may be possible to set an area of interest in an adjacent area based on the host vehicle and select the object of interest from other vehicles positioned within the set area of interest (e.g., vehicles detected in adjacent lanes within a defined region extending longitudinally from the host vehicle, etc.).

For example, according to the present disclosure, in response to setting the area of interest, it may be possible to set a rectangular area including the left line and the right line as the area of interest based on 100 m in front and 50 m in the rear, which are half of a sensor confidence area of the host vehicle (e.g., as derived from radar and lidar effective range models, etc.).

Furthermore, in response to selecting an object of interest, it may be possible to exclude another vehicle positioned within the area of interest from the object of interest in a case where the other vehicle is traveling at a higher preset reference speed compared to a speed of the host vehicle, and select a third vehicle that is partially positioned within the area of interest as a candidate for the object of interest (e.g., slower-moving vehicles likely to persist in adjacent lanes, etc.).

Next, according to the present disclosure, it may be possible to determine blind spots for each object of interest based on a relative speed of the selected object of interest (S30).

Next, according to the present disclosure, in response to determining the blind spot for each object of interest, it may be possible to determine an expected position after n seconds based on the relative speed of the host vehicle and the object of interest, and determine the blind spot for each object of interest based on the expected position after n seconds (e.g., assuming uniform relative velocity and no lane deviation, etc.).

Next, according to the present disclosure, it may be possible to determine risk areas of interest for each object of interest from among the generated blind spots, and determine an avoidance priority by dividing the risk areas of interest based on the overlap between the determined risk areas of interest (S40) (e.g., by identifying shared space among multiple blind spots to prioritize avoidance zones, etc.).

Herein, according to the present disclosure, it may be possible to search for intersections of opposite lines of a driving lane and the blind spot of the object of interest based on the host vehicle, search for an orthogonal point of an opposite line thereto based on the intersections, and determine the risk area of interest for each object of interest based on the intersections and the orthogonal point (e.g., geometrically defining the hazard zone for motion planning, etc.).

Furthermore, according to the present disclosure, it may be possible to divide the risk area of interest based on an overlap which occurs between risk areas of interest for each object of interest (e.g., to resolve overlapping threats and assign localized priorities, etc.).

Furthermore, it may be possible to determine the avoidance priority for the divided risk areas of interest based on a distance from the host vehicle and a number of overlaps (e.g., higher priority to closer and more frequently overlapping zones, etc.).

Then, according to the present disclosure, it may be possible to determine the necessary acceleration and deceleration for escaping the blind spot in accordance with the avoidance priority (S50) (e.g., through bounded optimization based on target point and traffic constraints, etc.).

Herein, it may be possible to check the risk of objects of interest positioned on opposite lines based on the risk area of interest, select an escape target position based on the risk of the object of interest, and determine the necessary acceleration and deceleration to the escape target position based on a preset acceleration (e.g., constrained to a maximum of 2 m/s² to ensure smooth control transitions, etc.).

Next, according to the present disclosure, it may be possible to control the driving speed of the host vehicle such that the host vehicle accelerates and decelerates based on the required acceleration and deceleration (S60).

Next, according to the present disclosure, it may be possible to check whether the host vehicle has escaped from the blind spot (S70).

Furthermore, according to the present disclosure, it may be possible to terminate the function when the host vehicle escapes the blind spot (e.g., by verifying sufficient lateral clearance from surrounding vehicles and exiting the defined risk area, etc.).

As such, according to the present disclosure, it may be possible to prevent a dangerous situation that may arise in response to driving in a blind spot of another vehicle (e.g., collisions caused by unseen lane changes, etc.).

Furthermore, according to the present disclosure, it may be possible to enable safe driving without disrupting a highway traffic flow by accelerating and decelerating while considering an average speed of surrounding vehicles and a road speed limit (e.g., ensuring minimal disturbance during lane transitions or overtaking, etc.).

FIG. 14 shows an example computing system for a vehicle.

Referring to FIG. 14, the computing system 1000 includes at least one processor 1100 connected through a bus 1200, a memory 1300, a user interface input device 1400, a user interface output device 1500, and a storage 1600, and a network interface 1700 (e.g., Ethernet, CAN, or 5G V2X communication modules, etc.).

The processor 1100 may be a central processing unit (CPU) or a semiconductor device that performs processing on commands stored in the memory 1300 and/or the storage 1600 (e.g., microcontrollers or automotive-grade SoCs, etc.). The memory 1300 and the storage 1600 may include various types of volatile or nonvolatile storage media. For example, the memory 1300 may include a read only memory (ROM) and a random access memory (RAM).

Accordingly, steps of a method or algorithm described in connection with the examples included herein may be directly implemented by hardware, a software module, or a combination of the two, executed by the processor 1100 (e.g., real-time operating system firmware, embedded C/C++ logic, or FPGA microcode, etc.). The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM (e.g., SD cards, SSDs, USB drives, or onboard NOR flash, etc.).

An exemplary storage medium is coupled to the processor 1100, which can read information from and write information to the storage medium. Alternatively, the storage medium may be integrated with the processor 1100. The processor and the storage medium may reside within an application specific IC (ASIC). The ASIC may reside within a user terminal (e.g., a central vehicle controller or autonomous driving module, etc.). Alternatively, the processor and the storage medium may reside as separate components within the user terminal.

An example of the present disclosure provides a driving control apparatus including an interface to which driving information of another vehicle around a host vehicle is input, and a processor configured to control a driving speed of the host vehicle in response to a case where the host vehicle enters a blind spot of the other vehicle, and the processor may be configured to select an object of interest from the other vehicle in response to a case where is positioned in the blind spot of the other vehicle, determine risk areas of interest for each object of interest based on a relative speed of the selected object of interest, determine necessary acceleration and deceleration for escaping the blind spot in accordance with the risk areas of interest, and control a driving speed of the host vehicle based on the necessary acceleration and deceleration.

In an example of the present disclosure, the processor may be configured to obtain the driving information of the other vehicle, filter objects of interest based on the driving information of the other vehicle, and search for a position of the blind spot of the other vehicle based on the host vehicle to determine whether the host vehicle is positioned in the blind spot of the other vehicle.

In an example of the present disclosure, the processor may be configured to determine a driving speed of the other vehicle from the driving information of the other vehicle, select a vehicle that is driving at a preset reference speed or higher compared to a speed of the host vehicle based on the driving speed of the other vehicle, and filter the selected vehicle by not selecting it as an object of interest, in a case of filtering the object of interest.

In an example of the present disclosure, the processor may be configured to set an area of interest in an adjacent area based on the host vehicle and select the object of interest from other vehicles positioned within the set area of interest, in a case of selecting the object of the interest.

In an example of the present disclosure, the processor may be configured to exclude another vehicle positioned within the area of interest from the object of interest in response to a case where the other vehicle is traveling at a higher preset reference speed compared to a speed of the host vehicle, and select a third vehicle that is partially positioned within the area of interest as a candidate for the object of interest, in a case of selecting the object of interest.

In an example of the present disclosure, the processor may be configured to determine an expected position after n seconds based on a relative speed of the host vehicle and the object of interest, determine a blind spot for each object of interest based on the expected position after n seconds, and determine risk areas of interest for each object of interest from among the determined blind spots, in response to determining the risk area of interest for each object of interest.

In an example of the present disclosure, the processor may be configured to search for intersections of opposite lines of a driving lane and the blind spot of the object of interest based on the host vehicle, search for an orthogonal point of an opposite line thereto based on the intersections, and determine the risk area of interest for each object of interest based on the intersections and the orthogonal point, in response to determining the risk area of interest for each object of interest.

In an example of the present disclosure, the processor may be configured to divide risk areas of interest based on an overlap between the risk areas of interest for each object of interest to determine avoidance priority for the risk areas of interest, in response to determining the risk area of interest for each object of interest.

In an example of the present disclosure, the processor may be configured to check whether there is a first overlapping area in which a vertical width of the risk area of interest is smaller than an overall length of the host vehicle in response to a case where the overlapping area includes a plurality of overlapping areas, and merge the first overlapping area into an adjacent overlapping area in response to a case where there is the first overlapping area in which the vertical width of the risk area of interest is smaller than the overall length of the host vehicle.

In an example of the present disclosure, the processor may be configured to determine the avoidance priority for the divided risk areas of interest based on a distance from the host vehicle and a number of overlaps, in response to determining the avoidance priority.

In an example of the present disclosure, the processor may be configured to determines an avoidance priority for the risk areas of interest based on a first distance from a front bumper of the host vehicle to an end point of a risk area of interest closest to a rear bumper of the host vehicle, a second distance from the rear bumper of the host vehicle to an end point of a risk area of interest closest to the front bumper of the host vehicle, a median of the first distance and the second distance, a total distance of the risk areas of interest, a number of overlaps, and a priority determination value.

In an example of the present disclosure, the processor may be configured to check a risk of objects of interest positioned on opposite lines based on the risk area of interest, select an escape target position based on the risk of the object of interest, and determine the necessary acceleration and deceleration to the escape target position based on a preset acceleration, in response to determining the necessary acceleration and deceleration for escaping the blind spot.

In an example of the present disclosure, the processor may be configured to determine the object of interest is at a high risk in a case where a minimum distance dₛ₁ between a lane in a direction of the host vehicle and the object of interest in a lane occupied by the object of interest is less than a first distance, and a vertical distance dₛ₂ between a center of the lane occupied by the object of interest and a center of the object of interest exceeds a second distance, in response to checking the risk of the object of interest.

In an example of the present disclosure, the processor may be configured to select a position where the host vehicle exits the blind spot after n seconds as a point of the escape target position in a case where there is no high-risk object of interest, and select a position of the rear bumper of the object of interest after n seconds as a point of the escape target position so as not to pass next to a high-risk object of interest among the risk areas of interest in a case where there is the high-risk object of interest, in response to selecting the escape target position.

Another example of the present disclosure provides a vehicle system including: a power control apparatus configured to control a power of a host vehicle, and a driving control apparatus configured to control the power control apparatus to accelerate or decelerate a driving speed of the host vehicle in response to a case where the host vehicle enters a blind spot of another vehicle around the host vehicle, wherein the driving control apparatus may be configured to select an object of interest from the other vehicle in response to a case where is positioned in the blind spot of the other vehicle, determine risk areas of interest for each object of interest based on a relative speed of the selected object of interest from among the determined blind spots, determine necessary acceleration and deceleration for escaping the blind spot in accordance with the risk areas of interest, and control a driving speed of the host vehicle based on the necessary acceleration and deceleration.

Another example of the present disclosure provides a driving control method including selecting, by the processor, an object of interest from another vehicle in response to a case where the host vehicle is positioned in the blind spot of the other vehicle, determining, by the processor, risk areas of interest for each object of interest, determining, by the processor, necessary acceleration and deceleration for escaping the blind spots in accordance with the risk areas of interest, and controlling, by the processor, a driving speed of the host vehicle based on the necessary acceleration and deceleration.

The above description is merely illustrative of the technical idea of the present disclosure, and those skilled in the art to which the present disclosure pertains may make various modifications and variations without departing from the essential characteristics of the present disclosure.

Therefore, the examples disclosed in the present disclosure are not intended to limit the technical ideas of the present disclosure, but to explain them, and the scope of the technical ideas of the present disclosure is not limited by these examples. The protection range of the present disclosure should be interpreted by the claims below, and all technical ideas within the equivalent range should be interpreted as being included in the scope of the present disclosure.

What is claimed:

1. An apparatus of a vehicle, the apparatus comprising:
an input interface configured to receive driving information of at least one vehicle within a threshold distance from the vehicle; and
a processor circuit configured to:
based on the vehicle being positioned in a blind spot of the at least one vehicle, select, as objects of interest, the at least one vehicle, wherein the blind spot corresponds to a region that is not visible from a driver seat of the at least one vehicle,
determine, based on a speed difference between the vehicle and each of the selected objects of interest, a risk area of interest for each of the selected objects of interest,
output, based on the risk areas of interest, a signal indicating an acceleration value and a deceleration value for escaping the blind spot, and
control, based on the signal, a driving speed of the vehicle.

2. The apparatus of claim 1, wherein the processor circuit is configured to:
obtain the driving information,
filter, based on the driving information, the objects of interest, and
search for a position of the blind spot of the at least one vehicle.

3. The apparatus of claim 2, wherein the processor circuit is configured to:
determine, based on the driving information, a driving speed of the at least one vehicle,
select, based on the driving speed of the at least one vehicle, a target vehicle, among the at least one vehicle, that is driving at a speed higher than a speed of the vehicle by at least a preset reference value, and
exclude the selected target vehicle from being designated as an object of interest for filtering the objects of interest.

4. The apparatus of claim 2, wherein the processor circuit is configured to:
set a second point where a right lane boundary of a lane next to a current lane, in which the vehicle is located, meets a straight line drawn at a first angle from a first point at an upper left side of the vehicle,
set a fourth point where the right lane boundary of the lane next to the current lane meets a straight line drawn at a second angle from a third point at a lower right side of the vehicle, and
based on the vehicle being positioned within a region defined by the first, second, third, and fourth points, determine that the vehicle is positioned in the blind spot of the at least one vehicle.

5. The apparatus of claim 4, wherein the processor circuit is configured to:
set a fifth point where a left lane boundary of the current lane, in which the vehicle is located, meets a foot of a perpendicular drawn from the first point to the left lane boundary,
set a sixth point where the right lane boundary of the lane next to the current lane meets a straight line drawn at a first angle from the fifth point,
set a seventh point and an eighth point where the left lane boundary of the current lane, in which the vehicle is located, and the right lane boundary of the lane next to the current lane, respectively, meet a foot of a perpendicular drawn from the third point to the left lane boundary, and
set a search range based on a position of the vehicle such that an area defined by the fifth, sixth, seventh, and eighth points comprises the blind spot of the at least one vehicle.

6. The apparatus of claim 2, wherein the processor circuit is configured to:
set a sixth point where a left lane boundary of a lane next to a current lane, in which the vehicle is located, meets a straight line drawn at a first angle from a fifth point located at an upper right side of the vehicle,
set an eighth point where the left lane boundary of the lane next to the current lane meets a straight line drawn at a second angle from a seventh point located at a lower left side of the vehicle, and
based on the vehicle being positioned within a region defined by the fifth, sixth, seventh, and eighth points, determine that the vehicle is positioned in the blind spot of the at least one vehicle.

7. The apparatus of claim 6, wherein the processor circuit is configured to:
set a ninth point where a right lane boundary of the current lane, in which the vehicle is located, meets a foot of a perpendicular drawn from the fifth point to the right lane boundary,
set a tenth point where the left lane boundary of the lane next to the current lane meets a straight line drawn at a first angle from the ninth point,
set an eleventh point and a twelfth point where the right lane boundary of the current lane and the left lane boundary of the lane next to the current lane, respectively, meet a foot of a perpendicular drawn from the seventh point to the right lane boundary, and
set a search range based on a position of the vehicle such that an area defined by the ninth, tenth, eleventh, and twelfth points comprises the blind spot of the at least one vehicle.

8. The apparatus of claim 1, wherein the processor circuit is configured to:
set, based on a position of the vehicle, an area of interest in an area adjacent to the vehicle, and
select, based on the at least one vehicle being positioned within the set area of interest, the objects of interest among the at least one vehicle.

9. The apparatus of claim 8, wherein the processor circuit is configured to:
based on a second vehicle traveling at a speed higher than a speed of the vehicle by at least a preset reference value, exclude the second vehicle positioned within the area of interest from the objects of interest, and
select a third vehicle that is partially positioned within the area of interest as a candidate for one of the objects of interest.

10. The apparatus of claim 1, wherein the processor circuit is configured to:
based on a speed difference between the vehicle and each of the objects of interest, determine an expected position of each of the objects of interest after a predetermined time interval,
determine, based on the expected position after the predetermined time interval, a blind spot for each of the objects of interest, and
determine, among the determined blind spot for each of the objects of interest, a risk area of interest for each of the objects of interest.

11. The apparatus of claim 1, wherein the processor circuit is configured to:
identify, based on a position of the vehicle, intersections between a lane boundary of a current lane, in which the vehicle is driving, and a boundary of a blind spot of each of the objects of interest,
determine, based on the identified intersections, an orthogonal point on the lane boundary of the current lane, and
determine, based on the identified intersections and the determined orthogonal point, a risk area of interest for each of the objects of interest.

12. The apparatus of claim 1, wherein the processor circuit is configured to:
based on overlaps between the risk areas of interest for each of object of the selected objects of interest, divide the risk areas into non-overlapping risk areas of interest, and
determine an avoidance priority for each of the non-overlapping risk areas of interest.

13. The apparatus of claim 12, wherein the processor circuit is configured to:
based on an overlapping area formed by overlaps between a plurality of risk areas of interest, determine whether a risk area of interest included in the overlapping area has a vertical width smaller than an overall length of the vehicle, and
merge, based on the vertical width of the risk area of interest being smaller than the overall length of the vehicle, the overlapping area into an adjacent overlapping area.

14. The apparatus of claim 12, wherein the processor circuit is configured to determine the avoidance priority based on a distance from the vehicle and a number of the overlaps between the risk areas of interest.

15. The apparatus of claim 12, wherein the processor circuit is configured to determine the avoidance priority based on:
a first distance from a front bumper of the vehicle to an end point of a risk area of interest closest to a rear bumper of the vehicle,
a second distance from the rear bumper of the vehicle to an end point of a risk area of interest closest to the front bumper of the vehicle,
a median of the first distance and the second distance,
a distance spanned by each of the risk areas of interest along a driving direction of the vehicle,
a number of overlaps among the risk areas of interest, and
a priority determination value determined based on the median, the distance, and the number of overlaps.

16. The apparatus of claim 1, wherein the processor circuit is configured to:
determine, based on a corresponding risk area of interest, a risk level of each of the objects of interest positioned in a lane adjacent to and in opposite direction from a current lane in which the vehicle is driving,
select, based on the determined risk level of each of the objects of interest, an escape target position of the vehicle, and
determine, based on a preset acceleration value, an acceleration value and a deceleration value for the vehicle to reach the escape target position.

17. The apparatus of claim 16, wherein the processor circuit is configured to:
determine that an object of interest is at a high risk based on:
a minimum distance between a lane in a direction of the vehicle and the object of interest in a lane occupied by the object of interest being less than a first threshold, and
a vertical distance between a center of the lane occupied by the object of interest and a center of the object of interest exceeding a second threshold.

18. The apparatus of claim 16, wherein the processor circuit is configured to:
based on absence of an object of interest having a risk level exceeding a threshold, select, as a point of the escape target position, a position where the vehicle exits the blind spot after a predetermined time period, and
based on presence of an object of interest having a risk level exceeding the threshold, select, as a point of the escape target position, a position corresponding to a rear bumper of the object of interest having a risk level exceeding the threshold after the predetermined time period, to prevent the vehicle from passing adjacent to the object of interest having the risk level exceeding the threshold.

19. An apparatus of a vehicle, the apparatus comprising:
a processor; and
a memory storing at least one instruction that, when executed by the processor communicating with the memory, is configured to cause the apparatus to:
receive information related to positions and speeds of a plurality of vehicles within a threshold distance from the vehicle;
determine whether the vehicle is located within a blind spot of at least one of the plurality of vehicles, wherein the blind spot corresponds to an area within a threshold range of angles extending rearward from a side mirror of the at least one of the plurality of vehicles;
identify, based on a speed difference between the vehicle and each of the at least one of the plurality of vehicles, a risk area of interest for each of the at least one of the plurality of vehicles;
output, based on the risk areas of interests, a signal indicating a target position for exiting the blind spot; and
control, based on the signal, driving of the vehicle to move toward the target position.

20. A method performed by an apparatus of a vehicle, the method comprising:
receiving information related to positions and speeds of a plurality of vehicles within a threshold distance from the vehicle;
determining whether the vehicle is located within a blind spot of at least one of the plurality of vehicles, wherein the blind spot corresponds to an area within a threshold range of angles extending rearward from a side mirror of the at least one of the plurality of vehicles;
identifying, based on a speed difference between the vehicle and each of the at least one of the plurality of vehicles, a risk area of interest for each of the at least one of the plurality of vehicles;
outputting, based on the risk areas of interests, a signal indicating a target position for exiting the blind spot; and
controlling, based on the signal, driving of the vehicle to move toward the target position.
